(19) United States
(12) Patent Application Publication
(10) Pub. No.: US 2013/0346284 A1
(43) Pub. Date: Dec. 26, 2013

(54) NOVEL SYSTEMS AND PROCESSES FOR ENHANCED MICROLENDING

(71) Applicants: Lauren Nicole Cozart Stubbs, Charlotte, NC (US); Duncan Goldie-Scot, New York, NY (US)

(72) Inventors: Lauren Nicole Cozart Stubbs, Charlotte, NC (US); Duncan Goldie-Scot, New York, NY (US)

(21) Appl. No.: 13/533,711

(22) Filed: Jun. 26, 2012

(51) Int. Cl. G06Q 40/02

(52) U.S. Cl. 705/38

(57) ABSTRACT

A computer based system and method implements a loan assessment algorithm that accurately generates a numeric score for delivery to lending institutions. The score determined is low cast and rapid, thus meeting two key elements of microfinance.

The present invention is related to systems for enhancing a lending operation directed to microloans. In particular, the present invention is directed to systems and programming to assist in microlending operations and the enhanced qualification of loans having limited size and expense burdens.

### BACKGROUND

Economic growth and development in modern society depends on banking. Banks provide the capital that permits the investment most businesses need to thrive. This is most often done with loans. Lending practices vary, but typically involve some form of loan application and qualification process that permits the bank to safely loan money to businesses that need and can repay the loan.

Loan qualification is a dynamic process. It balances the current interest rate environment with the potential risk of delayed or failed repayment of the principal. The qualification process must be accurate for the risk exposure level and must be cost efficient. This is true regardless of the sophistication of the economy where these loans are being offered.

For example, many developing countries have rapidly growing capital markets and open economies with competitive products and services. As businesses grow in these areas, new sources of capital are needed to fund inventory and related expenses for the business. An exemplary business might be a roadside mobile café serving fast foods and drinks on a cash basis. Each morning the owner of the mobile café must restock his/her inventory before venturing out—and thus must front the costs from wholesale vendors. Other expenses include transportation and service labor. Collectively, this expense is either self-financed from earlier proceeds or raised in the form of a small short-term loan.

For these developing markets, there has been a growing business practice known as “microlending.” This practice involves the provision of small short-term loans for business operations that bypass many of the steps and processes normally associated with lending practices. Many of the borrowers are individuals with limited or no physical assets, no bank account or prior credit records, and occasionally no formal home address.

One aspect of “microfinancing” is discussed in U.S. Publication No. 2010/0332410A1 dated Dec. 30, 2010 to Robert Brown (the content of this publication is incorporated by reference.) However, there remain many difficult issues in creating a more fluid and risk-free environment for microloans.

The present application is directed to enhancing the microlending and/or microfinancing operations and products available to the market.

### BRIEF DESCRIPTION OF THE DRAWINGS

FIG. 1 is a functional block diagram depicting the overall system structure.

FIG. 2 is a graph depicting a loan response curve of risk scores for potential loan sizes.

FIG. 3 depicts three loan response curves for three different institutions.

FIG. 4 is a flow chart depicting the process of a loan risk analysis.

FIG. 5 is a diagram showing various models of Probability of Default.

FIG. 6 is a graph depicting separate Probability of Default Models against a loan size default curve.

### DETAILED PRESENTATION OF ILLUSTRATION

### Embodiment of the Invention

The present invention is directed to computer systems and communication networks to support microlending. In particular, the present invention is directed to systems hardware and programming to facilitate enhanced microlending operations.

The systems corresponding to present invention provide numerous features and benefits, and in particular, provide accelerated lending review and approval by lending agents, and accurate measurement of risk exposure on a rapid, cost efficient basis.

In one arrangement, the present invention applies the trackable financial records held by mobile communication firms regarding cell phone usage to permit the rapid and accurate assessment of default risk in microfinancial markets. In accordance with one aspect of this arrangement, these mobile communication firms will gain a revenue stream from the otherwise unused data.

In one arrangement, the present invention utilizes prepaid mobile cellular accounts as a vehicle for collecting information regarding a loan applicant to establish loan risk parameters. In a further arrangement, a server receives data regarding a pre-paid mobile account and applies a risk assessment algorithm to generate a risk “score” that is thereafter supplied to a microfinancial institution considering lending opportunities to that account loan applicant. The calculated score provides a numerical measure of the default risk for the proposed loan. In one embodiment, the risk score is a dollar amount (or other monetary value) of the suggested maximum loan amount.

The process can be applied to individual applicants or group applicants. A group applicant can be two neighbors that cultivate adjacent fields, a church committee or the like.

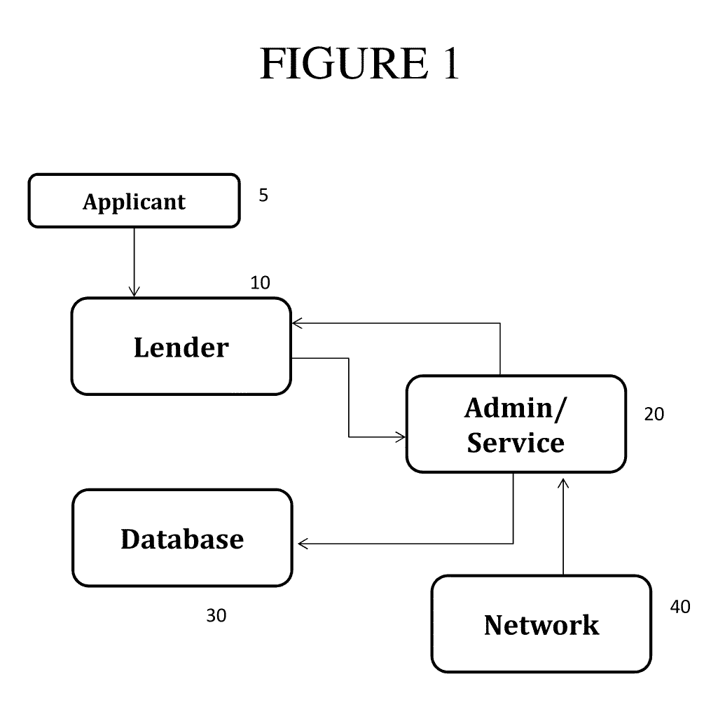

Turning now to FIG. 1, a functional block diagram depicts the overall system structure. Lender 10 receives a request for a small loan from an Applicant 5 (a borrower). The size of the loan can be $20 or $50 and possibly ranging upward to $5,000, but rarely more than this. These are very short-term loans, with repayment schedules measured in weeks, months and possibly a year or several years. Rate for these small, short-term loans may approach 25% API. Often the lender has some information on the borrower in its database, and this provides for an initial credit check. Borrowers also exist “off the grid” or network and without property ownership, limited residence information, limited tax and related governmental records, etc. In these instances, the lender is looking for a rapid credit check with little or no information on the applicant/borrower 5 in hand. In one arrangement, short-term loans can be risk assessed based on a (1) cell phone SIM card, (2) owner demographics and (3) recent credit history.

To utilize the inventive system, the lender 10 will forward to system administrator 20, the current cell phone number (or other identification code associated with the SIM card) of the applicant. This number is then used to collect other data internally and externally. In particular, the cell phone number provides a unique ID for accessing information regarding prior history for the applicant held by the administrator 20, from linked database 30. The cell phone number is also used to collect information from the network supporting the cell phone, i.e., the cell phone service provider. This will require select access from a cell phone provider such as Vodacom™, Tigo™, Airtel™ and Zantel™.

The information collected is applied to one or more score-generating algorithms employing a process that is discussed in more detail below. In particular, the system 20 includes a data processor controlled by stored program instructions and applies the algorithm that generates a numeric score corresponding to a credit default risk for the applicant 5. This score is then transferred back to the lender 10 and used in the approval process for the loan. The system 20 employs computer hardware, memory and communication links that accomplishes the foregoing in a very short window of time, delivering accurate credit default scores in near real time.

This is accomplished by use of the algorithm discussed below. In particular, the following illustrated approach is implemented on a high-speed server:

### Sample Equations

Logistic regressions with a binary dependent (Y) variable and multiple independent (X) variables, each multiplied by a coefficient to reflect the unit-change it would have on Y (% probability of default) with a one-unit change in X, all of which are also added to a constant, which in turn reflects the value of Y when all X terms are set to equal zero (also known as the Y-intercept).

Y=constant+β₁X₁+β₂X₂+β₃X₃+β₄X₄+β₅X₅+β₆X₆+β₇X₇+β₈X₈

where Y=probability of full default (1) vs. default (0)

So, for example:

% Probability of default=constant+0.0621 (gender)+0.004(age)−0.0012(age²) +0.0078(average prepaid balance)+0.034(average number of unique incoming callers per month)+ . . .

While speed and accuracy are concurrent objectives, the complexity of the equation may be adjusted depending on the needs for this particular application. To increase speed, fewer individual variables are used; for more accuracy, more may be applied and calculations may be iterative to reduce error further. In Table 1 below, a number of potentially valuable variables are identified as useful parameters in the above regression analysis.

TABLE I
Potential independent (x) variables for inclusion in this logistic regression:

Average prepaid balance for each of the last twelve months
List of all top up transactions (volume, date)
Top up regularity and frequency will be calculated from #3
Incoming call volume Outgoing call volume Number of unique incoming
calls (ie different numbers)
Number of unique outgoing calls (ie different numbers)
Geographical reach of incoming calls
Geographical reach of outgoing calls
Total number of incoming texts
Total number of outgoing texts
Distance between furthest points of the user's locations
Total miles travelled
Average length of incoming calls (exclude promotional ones unless
everyone gets the same ones), Average length of outgoing calls
Total number of minutes the phone is connected to the network
Total amount of time in use ie percentage activity metric for all activities
Texts coming from unique numbers
Texts going to unique numbers
Call regularity
Call frequency
Average prepay balance when new airtime is purchased
Number of SIM cards for given mobile operator
Length of time SIM card has been owned
Whether the SIM has been transferred to or from a different mobile
operator
Gender
Zip code of SIM registration (could also be useful to compare to zip code
of loan app)
Age/Date of Birth
Active mobile money account
Any payments to businesses/institutions (and volume, frequency, etc.)
Average balance in mobile money account
Number of missed calls per month
Data usage per month
Spending on extras (ringtones, etc)
Tariff/rate plan changes in past X months
Number of international calls incoming/outgoing

Similar to the above, there are potentially useful variables that may be collected from the lender, to enhance credit score accuracy, based on past experiences. These variables are used to enhance initial settings in the algorithm. These are presented below in Table II:

TABLE II
Potential variables from microfinance and/or banking institutions
that may be used in developing the initial predictive model:

Number of Phone Numbers Stored
Occupation Category
Number Of Kids
Number Of Dependents
Number Of People In Household
Age At First Loan
Default
Drop-Out
Loan Size Of Each Loan (Principal And Interest)
Loan Product
Individual Or Group
Savings Account Active
Savings Account Balance
Number of Loans
Where In Loan They Are At The Moment
Loan Term Interest Rates
Grace Period
Amortization Period
PAR > 1 (Portfolio at Risk = days in arrears)
PAR > 30
PAR > 60
PAR > 90
PAR > 180
PAR > 365
Write-Offs
Years Of Experience
Marital Status
Spouse Occupation
Years Of Education
Income
Collateral
Home Ownership/Rental
Collateral Size
Whether Documents Were Prepared At Time Of Application
Turnaround Time
Working Capital Vs. Physical Capital Vs. Consumption
Monetary Value Of Inventory
Relatives With Loans At The Same Mfi
Date Of Disbursement Of Each Loan
Rough Distance To Branch From Business Or House
MMT or cash disbursal
MMT or cash repayment

The algorithm may also take into account different levels of financial data. For example, global data, such as the Dow Jones Industrial average, or local/regional data, such as currency exchange rates for the region the loan is to be provided.

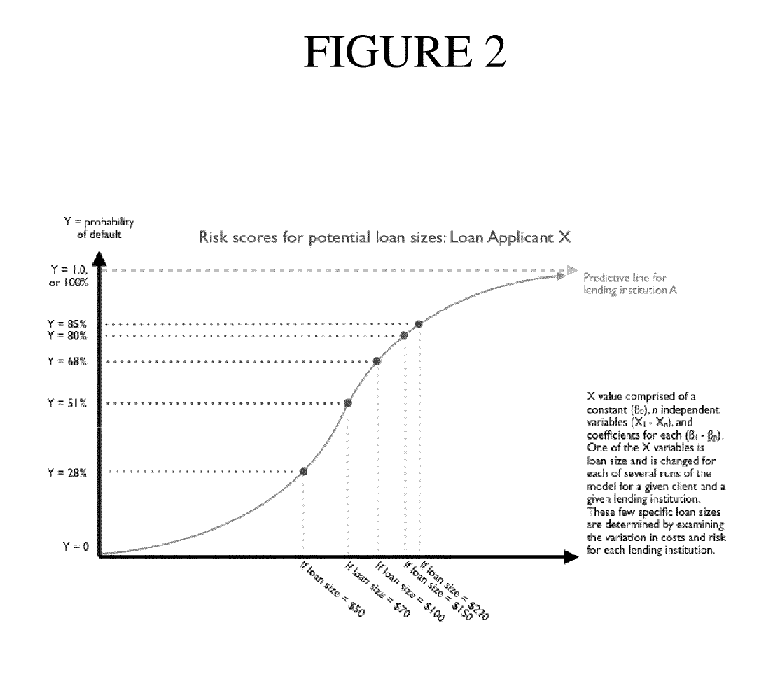

The regression analysis used in this invention generates a credit response curve corresponding to the risk of default as a function of various inputs. For example, the risk of default may increase with larger loans, and the graph of FIG. 2 summarizes this relationship for one lender based on experience in the microlending markets and based on a set of loan characteristics that are applied:

Y, or the % Probability of default=constant+0.0621 (gender)+0.004 (age)−0.0012 (age²)+0.0078 (average prepaid balance)+0.034 (average number of unique incoming callers per month)+0.020 (loan size) . . .

In addition to the regression analysis disclosed herein, other means for generating and optimizing the algorithm may be used. For example, machine learning algorithms, such as feed-forward neural networks may be used to “train” and dynamically update the algorithm coefficients.

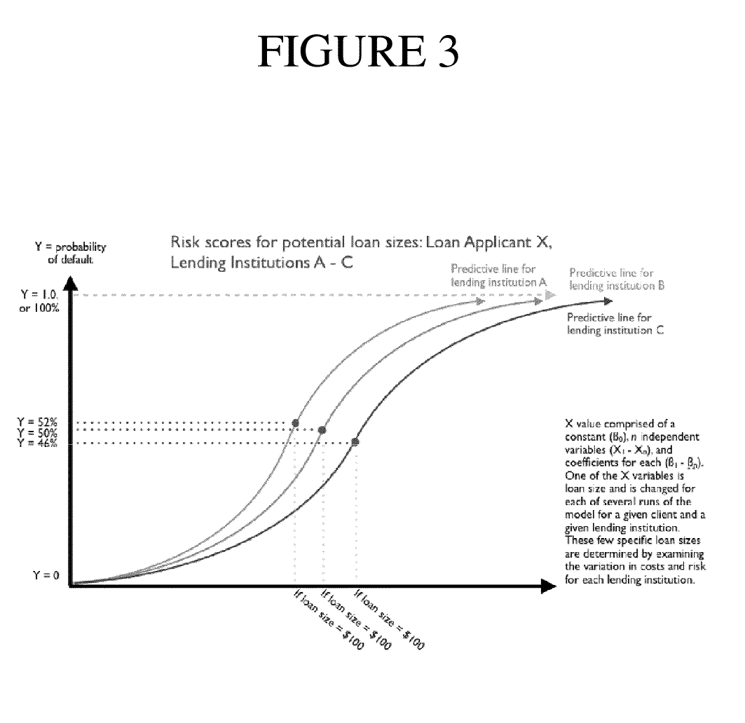

The graph of FIG. 3 depicts three loan response curves for three different institutions in accord with the regression analysis applied below. The three response curves demonstrate that the same loan may produce different risk assessments at one lender when compared to another.

The credit response curves are reflective of the default—loan relationship for individual applicants and lenders. The system 10 applies this relationship in creating a single risk score.

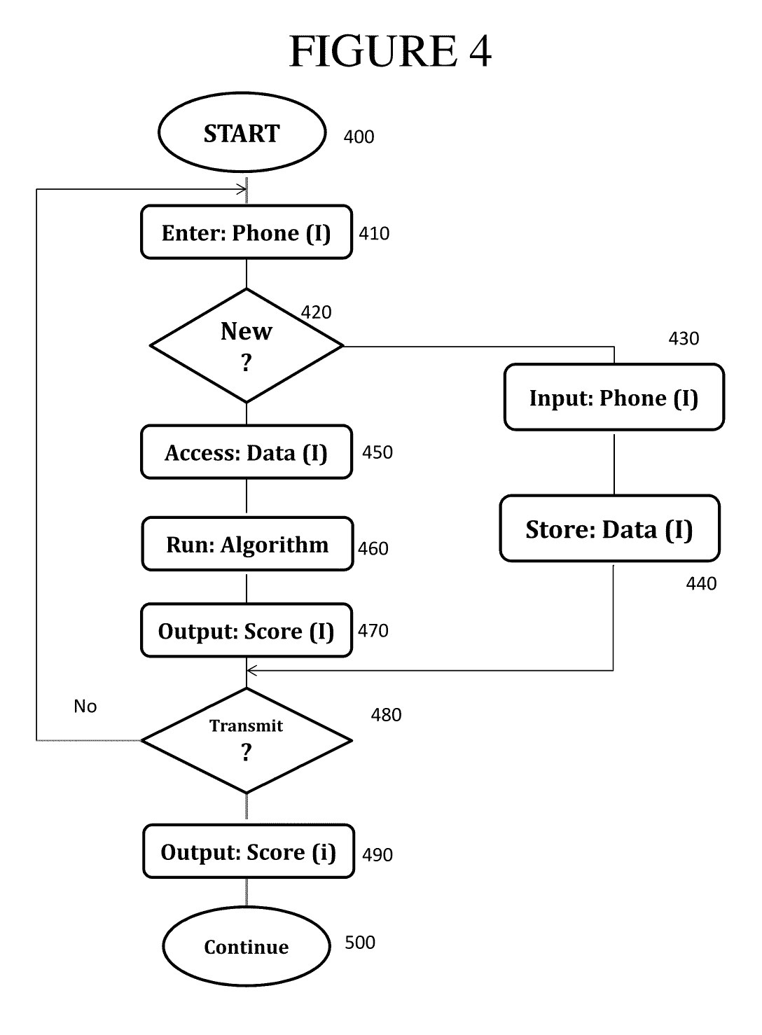

The foregoing process is depicted in flow chart form in FIG. 4. Beginning at block 400, control logic initiates the process and the phone (I) is entered at block 410. Test 420 determines if the phone number is new; if so, logic branches to input block 430 and the system creates a data address based on phone (I). At block 440, data (I) is collected and stored within the database—to be used in the processing algorithm.

Continuing in FIG. 4, for a recognized phone (I), the system accesses the proper, linked data (I), block 450, and runs the appropriate risk algorithm, block 460. Based on the selected calculations, a risk score is generated and return at block 470, as score (I). Test 480 determines whether the score (I) can be transmitted, using, for example, a quality assurance parameter. If so, logic outputs the score (I) to the lender block 490 and the system continues, block 500.

In addition to the predictive models provided, score management can be further facilitated. For example, past default data can be used to adjust the parameters in the regression analysis. In Table III, sample co-efficients are listed for individual lending institutions.

TABLE III
Sample data table of coefficients that might be used to comprise models for a variety of lending institutions:

| Lending | β0 | | | | | β5 | β6 | β7 | β8 | Sample full equations for |
|---|---|---|---|---|---|---|---|---|---|---|
| Institu- | Error | β1 | β2 | β3 | β4 | Average | Unique | Monthly | Frequency of | probability of default/ |
| tion | Term | Gender | Age | Age\hat{ }2 | Location | balance | Callers | expenditure | purchases | repayment |
| A | 0.14 | 0.21 | 0.0071 | 0.00856 | −0.012 | 0.4 | 0.06 | 0.008 | — | =0.14 + 0.21(gender) + |
| | | | | | | | | | | 0.0071(age) + 0.00856(age\hat{ }2) + |
| | | | | | | | | | | −0.012(location) + 0.4(average |
| | | | | | | | | | | balance) + 0.06(unique callers) + |
| | | | | | | | | | | 0.008(monthly expenditure) |
| B | 0.16 | 0.41 | 0.0171 | 0.00756 | −0.08 | 0.41 | 0.061 | 0.009 | 0.019 | =0.16 + 0.41(gender) + |
| | | | | | | | | | | 0.0171(age) + 0.00756(age\hat{ }2) + |
| | | | | | | | | | | −0.08(location) + 0.41(average |
| | | | | | | | | | | balance) + 0.061(unique callers) + |
| | | | | | | | | | | 0.009(monthly expenditure) + |
| | | | | | | | | | | 0.019(frequency of purchases) |
| C | 0.149 | 0.3 | 0.0091 | 0.00999 | −0.01002 | 0.39 | 0.056 | 0.0078 | 0.00178 | =0.149 + 0.3(gender) + |
| | | | | | | | | | | 0.0091(age) + 0.00999(age\hat{ }2) + |
| | | | | | | | | | | −0.01002(location) + 0.39 |
| | | | | | | | | | | (average balance) + 0.056 |
| | | | | | | | | | | (unique callers) + 0.0078 |
| | | | | | | | | | | (monthly expenditure) + 0.00178 |
| | | | | | | | | | | (frequency of purchases) |
| D | 0.152 | 0.29 | 0.0111 | 0.00956 | −0.0135 | 0.62 | — | 0.0081 | 0.00181 | =0.152 + 0.29(gender) + |
| | | | | | | | | | | 0.0111(age) + 0.00956(age\hat{ }2) + |
| | | | | | | | | | | −0.0135(location) + 0.62(average |
| | | | | | | | | | | balance) + 0.0081(monthly |
| | | | | | | | | | | expenditure) + 0.00181(frequency |
| | | | | | | | | | | of purchases) |
| E | 0.139 | 0.209 | 0.007 | 0.00756 | −0.0125 | 0.409 | 0.08 | 0.0043 | 0.00143 | =0.139 + 0.209(gender) + |
| | | | | | | | | | | 0.007(age) + 0.00756(age\hat{ }2) + |
| | | | | | | | | | | −0.0125(location) + 0.409 |
| | | | | | | | | | | (average balance) + 0.08 |
| | | | | | | | | | | (unique callers) + 0.0043 |
| | | | | | | | | | | (monthly expenditure) + |
| | | | | | | | | | | 0.00143(frequency of purchases) |

As an output, one possible score, transmission will include multiple lines per score—there will only be one line per score/per microfinance institution, but each score will include several different Y values for different “bucket” sizes. A score might show the probability of default for different loan sizes, and each of these is a separate point on the sigmoid/S-shaped curve. So perhaps a given loan applicant at a given microfinance institution (MFI) would have a score comprising about 6 points on that one curve, and some of those would probably show too low a risk of repayment for the MFI's risk appetite. In one embodiment, the risk score is a dollar amount (or other monetary value) of the suggested maximum loan amount.

TABLE V
Sample data table of personal data that might be used to create a score with an existing model:

| | | | Gender | Location | Date | | Average | | Monthly | |
|---|---|---|---|---|---|---|---|---|---|---|
| First | Last | Phone | (F = 1, | (zip | of | | balance | Unique | expenditure | Frequency of |
| Name | Name | number | M = 0) | code) | birth | Age | (shillings) | Callers | (Shillings) | purchases |
| Aailyah | Mwangi | 1000001 | 1 | 73 | 1/18/71 | 41 | 1345 | 12 | 400 | 5 |
| Abasi | Natofi | 1000002 | 0 | 73 | 8/4/54 | 57 | 1873 | 4 | 2000 | 10 |
| Abiria | Mhina | 1000003 | 1 | 73 | 2/3/85 | 27 | 785 | 18 | 400 | 4 |
| Adilha | Arusi | 1000004 | 1 | 102 | 7/4/68 | 43 | 1234 | 81 | 1000 | 7 |
| Kumi | Sakina | 2000005 | 0 | 153 | 8/19/90 | 21 | 345 | 56 | 893 | 4 |
| Lamia | Nura | 2000006 | 0 | 86 | 7/16/71 | 40 | 112 | 34 | 345 | 6 |
| Latifu | Niara | 2000007 | 1 | 120 | 5/15/83 | 28 | 400 | 36 | 650 | 8 |
| Erika | Ruqayah | 2000008 | 1 | 69 | 2/19/75 | 37 | 630 | 31 | 600 | 7 |
| Masika | Sabra | 3000009 | 0 | 73 | 3/4/83 | 29 | 300 | 28 | 129 | 18 |
| Sadaka | Penzima | 3000010 | 0 | 81 | 11/14/61 | 50 | 125 | 29 | 27 | 77 |
| Malia | Pendo | 4000011 | 1 | 102 | 10/12/69 | 42 | 74 | 72 | 95 | 6 |
| Mkweli | Nena | 4000012 | 1 | 73 | 12/3/84 | 27 | 569 | 118 | 124 | 5 |
| Anza | Bado | 4000013 | 1 | 73 | 5/27/89 | 22 | 742 | 17 | 569 | 3 |
| Santilo | Asumini | 4000014 | 0 | 73 | 4/30/72 | 39 | 213 | 9 | 300 | 2 |

TABLE V
Sample data table showing how relevant telecoms/mobile network
operators (MNO) are identified by the beginning of each phone number:

| Mobile | Owned phone |
|---|---|
| Network | numbers begin with |
| Operator | digit |
| MobileCo | 1 |
| MobiCorp | 2 |
| SunMobile | 3 |
| MobileWorld | 4 |

### Example 1

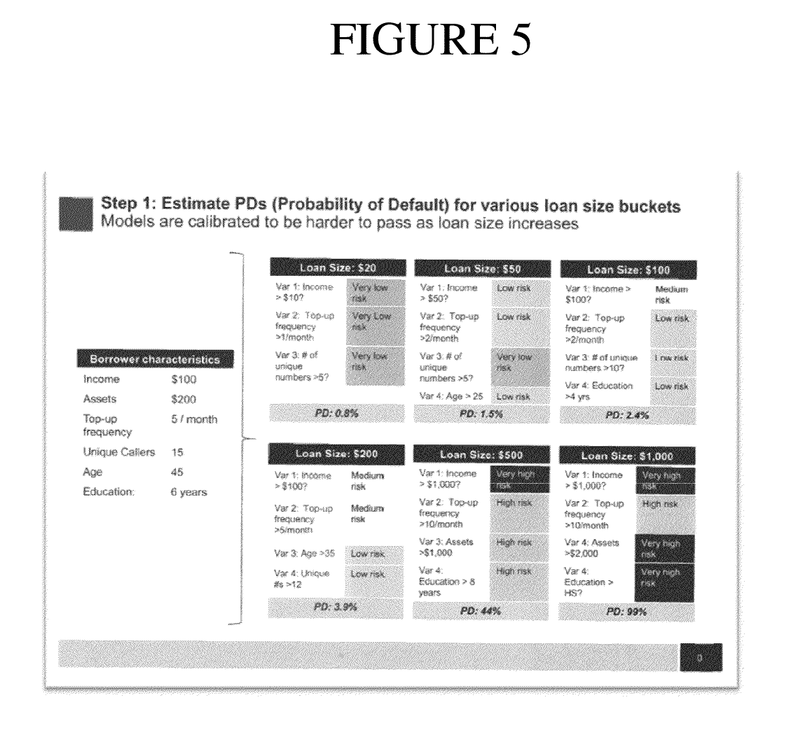

In this example a loan is sought from a borrower having the characteristics noted in FIG. 5: income of $100, assets of $200, top-up frequency of 5 times per month, 15 unique callers, age of 45, education of 6 years.

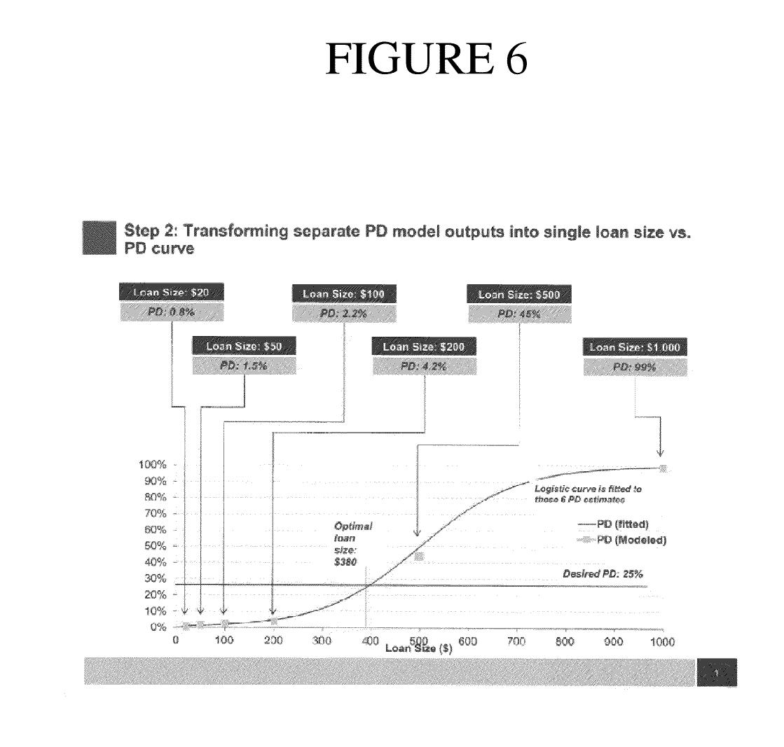

As processed by one embodiment of the present invention, the information contained in FIG. 5 translates into the probability distribution curve reflected in FIG. 6.

It is understood by those skilled in the art that the invention described above is applicable to home and educational loans, as well as business loans.

In one embodiment of the present invention, a lead generation component is provided. That is, the system may provide contact information of interested borrowers to lenders. In one example, a lender can specify the range of scores associated with potential leads that it wants to receive, so only leads with risk levels within the lender's risk tolerance are provided to the lender. Additionally, the system may receive or request updates from the lenders regarding loans provided or offered to borrowers, so that the system may remove those borrowers as potential leads from other lenders.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

What is a claimed:

1. A computer system for implementing a credit score distribution system associated with microfinance lending practices, said system comprising:
a) input data system, associated with a communication network, for receiving data, including a cell phone number and identification for one or more lending institutions;
b) data processor for implementing a regression analysis to determine credit default risk score based on plural stored variables; and
c) output link to distribute the credit default score as determined by said data processor.

2. The system of claim 1 wherein said regression analysis applies stored coefficients to said variables in calculating said score.

3. The system of claim 1 further comprising a database for records relating to applicants for microloans.
